(19) United States
(12) Patent Application Publication
(10) Pub. No.: US 2024/0349701 A1
(43) Pub. Date: Oct. 24, 2024

(54) Two-in-One Dog Training Device Integrating Functions of Dog Repeller

(71) Applicant: Zhixiong CHEN, Zhongshan (CN)

(72) Inventor: Zhixiong CHEN, Zhongshan (CN)

(21) Appl. No.: 18/135,801

(22) Filed: Apr. 18, 2023

(51) Int. Cl. A01K 27/00; A01K 15/02

(52) U.S. Cl. CPC A01K 27/009; A01K 15/021

(57) ABSTRACT

The disclosure provides a two-in-one dog training device integrating functions of a dog repeller. The two-in-one dog training device integrating functions of a dog repeller includes a host and a receiver fixedly worn on a pet body through a bandage and is connected with the host through a wireless signal; the host is provided with a dog training control key for controlling a vibration motor or electric shock electrodes respectively; the host is configured to transmit an instruction signal after receiving an instruction input by the dog training control key; the receiver is configured to receive the instruction signal and then warn and punish the pet according to the instruction signal; and the host is also provided with a dog repelling unit for repelling a dog; and the dog repelling unit includes a high-frequency sound wave generator and a dog repelling key for controlling the high-frequency sound wave generator.

### TECHNICAL FIELD

The disclosure relates to electronic products for pets, and particularly relates to a two-in-one dog training device integrating functions of a dog repeller.

### BACKGROUND

In the past, many people tried a forcing method to train dogs, and now, some people still use it. The method for forcing the dogs to obey through corporal punishment is the most unscientific method. Like other animals, the dogs have a very strong sense of vigilance on human. From the perspective of the dogs, being beaten and kicked for unknown causes may only lead to an impression of being “abused”. In case of facing a very powerful owner, the dogs may obey because of fear. However, the dogs growing up in such environment have a sense of extreme insecurity, and sometimes they may attack children or old people, and even cause dangerous incidents of biting people.

On the other hand, unfamiliar dogs sometimes may have face-to-face conflicts with people or dogs carried by people, and such conflicts sometimes may be very intense, especially when faced with large dogs or ferocious dogs. The unfamiliar dogs sometimes may cause unexpected harm to people. In case of conflicts between own dogs and other dogs, the owners may forcibly intervene to protect their own dogs, which often leads to accidental injuries.

### SUMMARY

An objective of the disclosure is to provide a two-in-one dog training device integrating functions of a dog repeller. The dog training device can be used as a dog training device and a dog repeller when necessary.

In one aspect, the disclosure provides a two-in-one dog training device integrating functions of a dog repeller, and the two-in-one dog training device integrating functions of a dog repeller includes a host and a receiver.

The receiver is fixedly worn on a pet body through a bandage and is connected with the host through a wireless signal;
the receiver includes a main control board; the main control board is connected with at least one of a vibration motor or an ultrasonic generator or electric shock electrodes;
the host is provided with a dog training control key for controlling the vibration motor or the electric shock electrodes respectively; the host is configured to transmit an instruction signal after receiving an instruction input by the dog training control key; the receiver is configured to receive the instruction signal and then warn and punish the pet according to the instruction signal so as to stop improper behaviors of the pet; and therefore, the aims of helping the pet to correct the improper behaviors and develop a good living habit are achieved;
the host is also provided with a dog repelling unit for repelling a dog; the dog repelling unit includes a high-frequency sound wave generator and a dog repelling key for controlling the high-frequency sound wave generator; and after being started through the dog repelling key, the high-frequency sound wave generator can generate a high-frequency sound wave to directly deter and punish the dog, then the dog can go away, and thus the aim of repelling one dog or a dog group is achieved.

According to the disclosure, the two-in-one dog training device integrating functions of a dog repeller can be used as a dog training device or a dog repeller. On one hand, the two-in-one dog training device integrating functions of a dog repeller can warn and punish the pet dog through the receiver so as to stop the improper behaviors of the pet dog; and therefore, the aims of helping the pet to correct the improper behaviors and develop a good living habit are achieved; and on the other hand, the high-frequency sound wave generator can also generate an instant and strong “explosive” high-frequency sound wave to stimulate the auditory and nervous systems of the dog, thus the dog can feel afraid, and the effect of repelling the dog is achieved.

Further, the receiver warns or punishes the pet dog by adopting at least one of the following modes to stop the improper behaviors of the pet dog:
the receiver generates vibration which can be sensed by the pet through the vibration motor;
or the ultrasonic generator generates an ultrasonic wave which can be sensed by the pet;
or the electric shock electrodes generate a high-voltage micro current to perform electric shock on the body surface skin of the pet.

By the above modes and means, the pet can be warned and punished to stop the improper behaviors, so that the aims of helping the pet to correct the improper behaviors and develop a good living habit are achieved.

Specifically, the dog training control key includes a vibration dog training control key for controlling the vibration motor, a vibration dog training control key for controlling the ultrasonic generator and a plurality of dog training control keys for controlling the electric shock electrodes.

Further, the high-frequency sound wave generator is arranged on the side face of the top end of the host. The high-frequency sound wave is high in directivity and can only be transmitted in one direction generally, so a sound source of the high-frequency sound wave is arranged on the side face of the top end of the host and can be conveniently aligned with the dog to be repelled in use, and the dog can conveniently know the source of the high-frequency sound wave. It is important for the dog to know the source of the high-frequency sound wave. Only when the dog knows the source of the high-frequency sound wave, can the dog feel afraid, and therefore the dog repelling effect is achieved.

In some implementations, the high-frequency sound wave generator can be started to generate the ultrasonic wave all the time after receiving an instruction from the dog repelling key and is stopped after receiving the instruction from the dog repelling key again. Meanwhile, the two-in-one dog training device integrating functions of a dog repeller in the disclosure can be shaken to make the dog know the source of the high-frequency sound wave and feel afraid.

In other implementations, the high-frequency sound wave generator can be started to periodically generate the high-frequency sound wave after receiving the instruction from the dog repelling key. Therefore, a situation can be avoided that the dog is simulated by the high-frequency sound wave generated all the time to attack people due to excessive response.

Specifically, the high-frequency sound wave generator can be started to continuously generate the high-frequency sound wave for 2-5 s after receiving the instruction from the dog repelling key, and then can continuously generate the ultrasonic wave for 2-5 s every 2-5 s, and the process is repeated.

Preferably, the frequency of the high-frequency sound wave generator generating the high-frequency sound wave is 2,500-5,000 Hz. The high-frequency sound wave at this frequency is generally inaudible for human beings, but is quite harsh and extremely uncomfortable for the dog.

Preferably, the energy of the high-frequency sound wave generator generating the high-frequency sound wave is not less than 125 DB/30 cm. Therefore, the simulation and interference distance of harsh sound that makes the dog feel uncomfortable or unbearable may be 3 m or above. That is, the effective acting distance of the dog repeller can be greater than 3 m, and thus the dog can have enough time to know the source of the high-frequency sound wave and respond accordingly. It is especially important for a running dog.

Further, a plurality of LED lamp beads are arranged on the side face of the top end of the host; the LED lamp beads are arranged near the high-frequency sound wave generator and work synchronously with the high-frequency sound wave generator; and the LED lamp beads can generate high-frequency flash light during work. On one hand, the high-frequency flash light can warn and threaten the dog, and on the other hand, the high-frequency flash light can attract the dog to see the high-frequency sound wave generator, so that the dog can know the source of the high-frequency sound wave conveniently. In addition, the high-frequency flash light is visible for human beings and has a warning function, so that the high-frequency flash light can attract the attention of people around and help people conveniently when accidents occur.

Further, a display screen is arranged on the front face of the host. The display screen can conveniently display information such as the internal functions, the working state and the power and the electric shock intensity of the two-in-one dog training device.

### BRIEF DESCRIPTION OF FIGURES

FIG. 1 is a schematic structure diagram of a two-in-one dog training device integrating functions of a dog repeller according to an implementation of the disclosure.

FIG. 2 is an amplified diagram of a part A shown in FIG. 1.

FIG. 3 is an assembly diagram of a receiver shown in FIG. 1.

FIG. 4 is a circuit structure diagram of a receiver shown in FIG. 3.

FIG. 5 is a circuit structure diagram of a host shown in FIG. 1.

### DETAILED DESCRIPTION

The disclosure is further described in detail below in combination with the accompanying drawings.

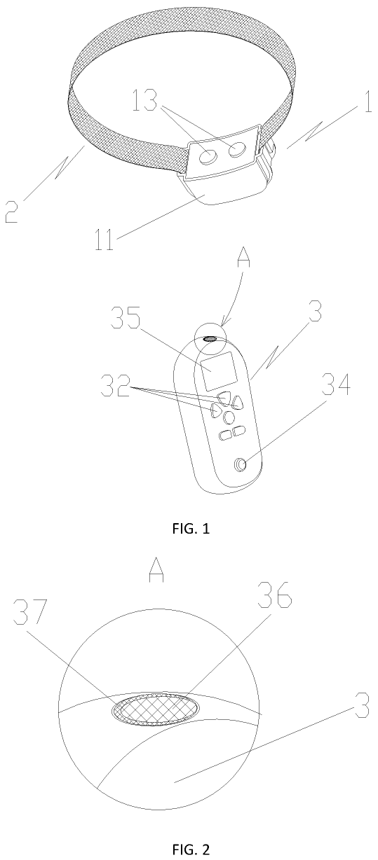

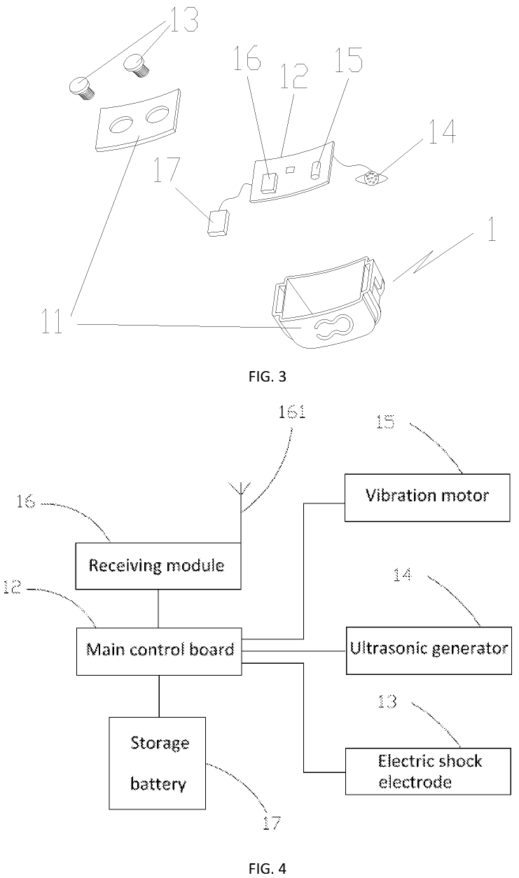

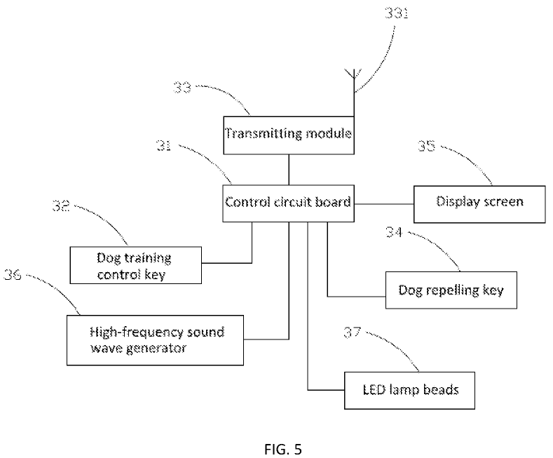

FIG. 1 to FIG. 5 schematically show a two-in-one dog training device integrating functions of a dog repeller according to an implementation of the disclosure.

As shown in the figures, the device includes a host 3 and a receiver 1.

The receiver 1 is fixedly worn on a pet body through a bandage 2 and is connected with the host 3 through a wireless signal.

The receiver 1 includes a shell 11 and a main control board 12 arranged in the shell 11.

The main control board 12 is also connected with a storage battery 17. The storage battery 17 is a dry battery or a rechargeable battery and is configured to provide working current for the main control board 12.

Electric shock electrodes 13 are arranged outside the shell 11, and the electric shock electrodes 13 are close to the skin of the pet. The electric shock electrodes 13 are connected with the main control board 12 and receive instructions from the main control board 12.

In the example, a vibration motor 15 and an ultrasonic generator 14 are also arranged in the shell 11. The vibration motor 15 and the ultrasonic generator 14 are respectively connected with the main control board 12 and receive instructions from the main control board 12.

A plurality of dog training control keys 32 are arranged on the surface of the host 3.

A dog training control key 34 is configured to respectively control the vibration motor 15 or the ultrasonic generator 14 or the electric shock electrodes 13.

In the example, the dog training control key 34 includes a plurality of dog training control keys such as a vibration dog training control key for controlling the vibration motor 15, a vibration dog training control key for controlling the ultrasonic generator 14 and an electric shock dog training control key for controlling the electric shock electrodes 13.

As shown in the figures, the host 3 is also provided with a control circuit board 31, a transmitting module 33 and a display screen 35.

The display screen 35 is arranged on the front face of the host 3. The display screen 35 can conveniently display information such as the internal functions, the working states and the power and the electric shock intensity of the two-in-one dog training device.

The dog training control keys 32, the transmitting module 33 and the display screen 35 are respectively connected with the control circuit board 31.

The host 3 is provided with a transmitting antenna 331 for transmitting a radio signal. The transmitting antenna 331 is connected with the transmitting module 33.

The host 3 uses the rechargeable battery as a power supply to provide the working current.

In the example, the main control board 12 is also connected with a receiving

module 16 for receiving a signal from the transmitting module 33. The receiving module 16 is provided with a receiving antenna 161 and is matched with the transmitting module 33.

The host 3 is configured to transmit an instruction signal after receiving an instruction input by the dog training control keys 32; the receiver 1 is configured to receive the instruction signal and then warn and punish the pet according to the instruction signal so as to stop improper behaviors of the pet; and therefore, the aims of helping the pet to correct the improper behaviors and develop a good living habit are achieved.

In the example, when the host 3 works in an electronic fence mode, the receiver 1 will adopt at least one of the following modes to warn and urge the pet to correct the improper behaviors and develop a good living habit:
(a) the receiver 1 generates vibration which can be sensed by the pet through the vibration motor 15;
(b) or the ultrasonic generator 14 generates an ultrasonic wave which can be sensed by the pet;
(c) or the electric shock electrodes 13 generate a high-voltage micro current to perform electric shock on the body surface skin of the pet.

In the example, the host 3 is further provided with a dog repelling unit for repelling a dog. The dog repelling unit includes a high-frequency sound wave generator 36 and a dog repelling key 34 for controlling the high-frequency sound wave generator. After the high-frequency sound wave generator 36 is started through the dog repelling key 34, the high-frequency sound wave generator 36 will generate a high-frequency sound wave to directly deter and punish the dog, then the dog can go away, and the aim of repelling one dog or a dog group is achieved.

According to the disclosure, the two-in-one dog training device integrating functions of a dog repeller can be used as a dog training device or a dog repeller. On one hand, the two-in-one dog training device integrating functions of a dog repeller can warn and punish the pet dog through the receiver so as to stop the improper behaviors of the pet dog; and therefore, the aims of helping the pet to correct the improper behaviors and develop a good living habit are achieved; and on the other hand, the high-frequency sound wave generator can also generate an instant and strong “explosive” high-frequency sound wave to stimulate the auditory and nervous systems of the dog, thus the dog can feel afraid, and the effect of repelling the dog is achieved.

In the example, the high-frequency sound wave generator 36 is arranged on the side face of the top end of the host 3. The high-frequency sound wave is high in directivity and can only be transmitted in one direction generally, so a sound source of the high-frequency sound wave is arranged on the side face of the top end of the host 3 and can be conveniently aligned with the dog to be repelled in use, and the dog can conveniently know the source of the high-frequency sound wave. It is important for the dog to know the source of the high-frequency sound wave. Only when the dog knows the source of the high-frequency sound wave, can the dog feel afraid, and therefore the dog repelling effect is achieved.

In the example, the high-frequency sound wave generator 36 can be started to periodically generate the high-frequency sound wave after receiving the instruction from the dog repelling key 34. Therefore, a situation can be avoided that the dog is simulated by the high-frequency sound wave generated all the time to attack people due to excessive response.

Specifically, the high-frequency sound wave generator 36 can be started to continuously generate the high-frequency sound wave for 2-5 s after receiving the instruction from the dog repelling key, and then can continuously generate the ultrasonic wave for 2-5 s every 2-5 s, and the process is repeated.

In other examples, the high-frequency sound wave generator 36 can also be started to generate the ultrasonic wave all the time after receiving the instruction from the dog repelling key 34 and is stopped after receiving the instruction from the dog repelling key 34 again. Meanwhile, the two-in-one dog training device integrating functions of a dog repeller in the disclosure can be shaken to make the dog know the source of the high-frequency sound wave and feel afraid.

The frequency of the high-frequency sound wave generator 36 generating the high-frequency sound wave is 2,500-5,000 Hz. The high-frequency sound wave at this frequency is generally inaudible for human beings, but is quite harsh and extremely uncomfortable for the dog.

Meanwhile, the energy of the high-frequency sound wave generator 36 generating the high-frequency sound wave is not less than 125 DB/30 cm. Therefore, the simulation and interference distance of harsh sound that makes the dog feel uncomfortable or unbearable may be 3 m or above. That is, the effective acting distance of the dog repeller can be greater than 3 m, and thus the dog can have enough time to know the source of the high-frequency sound wave and respond accordingly. It is especially important for a running dog.

A plurality of LED lamp beads 37 are further arranged on the side face of the top end of the host 3.

The LED lamp beads 37 are arranged near the high-frequency sound wave generator 36 and work synchronously with the high-frequency sound wave generator 36.

The LED lamp beads 37 can generate high-frequency flash light during work. On one hand, the high-frequency flash light can warn and threaten the dog, and on the other hand, the high-frequency flash light can attract the dog to see the high-frequency sound wave generator, so that the dog can know the source of the high-frequency sound wave conveniently. In addition, the high-frequency flash light is visible for human beings and has a warning function, so that the high-frequency flash light can attract the attention of people around and help people conveniently when accidents occur.

The above described are only some implementations of the disclosure. For those of ordinary skills in the art, without departing from the inventive concept of the disclosure, a plurality of modifications and improvements can be made, all of which fall within the scope of protection of the disclosure.

What is claimed is:

1. A two-in-one dog training device integrating functions of a dog repeller, comprising a host and a receiver, wherein
the receiver is fixedly worn on a pet body through a bandage and is connected with the host through a wireless signal;
the receiver comprises a main control board; the main control board is connected with at least one of a vibration motor or an ultrasonic generator or electric shock electrodes;
the receiver warns or punishes the pet dog by adopting at least one of the following modes to stop the improper behaviors of the pet dog:
the receiver generates vibration which can be sensed by the pet through the vibration motor;
or the ultrasonic generator generates an ultrasonic wave which can be sensed by the pet;
or the electric shock electrodes generate a high-voltage micro current to perform electric shock on the body surface skin of the pet;
the host is provided with a dog training control key for controlling the vibration motor or the electric shock electrode respectively; the host is configured to transmit an instruction signal after receiving an instruction input by the dog training control key; the receiver is configured to receive the instruction signal and then warn and punish the pet according to the instruction signal so as to stop improper behaviors of the pet; and therefore, the aims of helping the pet to correct the improper behaviors and develop a good living habit are achieved;
the host is also provided with a dog repelling unit for repelling a dog; the dog repelling unit comprises a high-frequency sound wave generator and a dog repelling key for controlling the high-frequency sound wave generator; and after being started through the dog repelling key, the high-frequency sound wave generator can generate a high-frequency sound wave to directly deter and punish the dog, then the dog can go away, and the aim of repelling the dog is achieved.

2. The two-in-one dog training device integrating functions of a dog repeller according to claim 1, wherein the dog training control key comprises a vibration dog training control key for controlling the vibration motor, a vibration dog training control key for controlling the ultrasonic generator and a plurality of dog training control keys for controlling the electric shock electrodes.

3. The two-in-one dog training device integrating functions of a dog repeller according to claim 1, wherein the high-frequency sound wave generator is arranged on the side face of the top end of the host.

4. The two-in-one dog training device integrating functions of a dog repeller according to claim 1, wherein the high-frequency sound wave generator can be started to generate the high-frequency sound wave all the time after receiving an instruction from the dog repelling key and is stopped after receiving the instruction from the dog repelling key again.

5. The two-in-one dog training device integrating functions of a dog repeller according to claim 1, wherein the high-frequency sound wave generator can be started to periodically generate the high-frequency sound wave after receiving the instruction from the dog repelling key.

6. The two-in-one dog training device integrating functions of a dog repeller according to claim 6, wherein the high-frequency sound wave generator can be started to continuously generate the high-frequency sound wave for 2-5 s after receiving the instruction from the dog repelling key, and then can continuously generate the ultrasonic wave for 2-5 s every 2-5 s, and the process is repeated.

7. The two-in-one dog training device integrating functions of a dog repeller according to claim 6, wherein the frequency of the high-frequency sound wave generator generating the high-frequency sound wave is 2,500-5,000 Hz; and the energy of the high-frequency sound wave generator generating the high-frequency sound wave is not less than 125 DB/30 cm.

8. The two-in-one dog training device integrating functions of a dog repeller according to claim 4, wherein a plurality of LED lamp beads are arranged on the side face of the top end of the host; the LED lamp beads are arranged near the high-frequency sound wave generator and work synchronously with the high-frequency sound wave generator; and the LED lamp beads can generate high-frequency flash light during work.

9. The two-in-one dog training device integrating functions of a dog repeller according to claim 1, wherein a display screen is arranged on the front face of the host.
